(19) United States
(12) Patent Application Publication
(10) Pub. No.: US 2024/0399784 A1
(43) Pub. Date: Dec. 5, 2024

(54) METHOD AND FILLING TOOL FOR PRODUCING A DECORATIVE ELEMENT WITH A FUNCTIONAL BODY AND A PLAIN DECORATIVE ELEMENT

(71) Applicant: Lisa Dräxlmaier GmbH, Vilsbiburg (DE)

(72) Inventors: Christian SCHLEMMER, Landshut (DE); Linda PAINTNER, Landshut (DE); Wolfgang STRASSER, Aham (DE)

(73) Assignee: Lisa Dräxlmaier GmbH, Vilsbiburg (DE)

(21) Appl. No.: 18/807,516

(22) Filed: Aug. 16, 2024

Related U.S. Application Data
(63) Continuation of application No. PCT/EP2023/053008, filed on Feb. 7, 2023.

(30) Foreign Application Priority Data
Feb. 16, 2022 (DE) 10 2022 103 623.5

(51) Int. Cl. B44C 3/10; B29C 45/14; B29L 31/30

(52) U.S. Cl. CPC B44C 3/10; B29C 45/14311; B29C 2045/14327; B29L 2031/3005

(57) ABSTRACT

A method and a filling tool used to produce a decorative element with a functional body for a motor vehicle. The functional body has a visible side and a rear side. A decorative blank with a visible side, an adhesive side, and an insertion opening corresponding to the functional body and a filling tool is provided. The filling tool includes a sealing unit which corresponds to the insertion opening of the decorative blank. The decorative blank is placed in the filling tool and the functional body is inserted into the associated insertion opening, so that an assembly formed from the decorative blank and the functional body is supported via the sealing unit. A non-destructively removable and fluid-tight fixation is formed between the sealing unit and the assembly on the visible sides. The insertion opening of the decorative cut is filled with a filling material.

### CROSS-REFERENCE TO RELATED APPLICATIONS

This application is a continuation of International Application No. PCT/EP2023/053008, filed on Feb. 7, 2023, which claims priority to and the benefit of DE 10 2022 103 623.5 filed on Feb. 16, 2022. The disclosure of each of the above referenced applications is incorporated herein by reference.

### FIELD

The present disclosure relates to a method for producing a decorative element that has one or more functional bodies and the decorative element.

### BACKGROUND

The statements in this section merely provide background information related to the present disclosure and may not constitute prior art.

DE 10 2008 023 778 B4 shows that to manufacture an accessory part, a structure-forming element is covered with an outer layer made of leather, textile or synthetic material. DE 10 2019 127 108 A1 also discloses a method for introducing a sensor film into a plastic component. DE 10 2018 215 735 A1 discusses a display device for a motor vehicle with a perforated decorative layer, with light shining through the openings in the decorative layer. DE 10 2019 135 217 A1 discloses a visible/interior component for the interior of a vehicle with a surface element that has a top and a bottom and is at least partially transparent in a visible spectral range. The visible/interior component further comprises a lighting unit via which the surface element can be illuminated with light from the underside.

### SUMMARY

This section provides a general summary of the disclosure and is not a comprehensive disclosure of its full scope or all of its features.

The present disclosure provides a particularly versatile and highly functional decorative element as efficiently and inexpensively as possible.

The present disclosure further relates to a filling tool that is used to produce the decorative element. In addition, the present disclosure relates to such a decorative element that was produced by means of the method according to the present disclosure, i.e. with the aid of the filling tool. In particular, the decorative element is intended to be used in the automotive sector for example, as an interior element and/or a decorative element in the interior of a motor vehicle such as a passenger car and/or truck. The following are possible interior and/or decorative elements: an instrument panel, a center console, a door panel, a roof liner, seats, headrests, seat cushions, upholstery elements, vehicle furniture, pillar trim, etc. Possible applications of such a decorative element for example include digitally functional surfaces by means of which a motor vehicle user, such as the driver of the same, can be provided with information, in particular about current or possibly changing variables of an at least partially autonomous driving mode of the motor vehicle. Alternatively or additionally—especially with regard to the constantly evolving miniaturization of those components—one or more electrical and/or electronic components can be used in the corresponding functional body, such as sensors (radar, ultrasound, camera, etc.), elements of passive and/or active safety systems, acoustically effective elements (loudspeakers, microphones, etc.), lighting elements (interior lighting, ambient lighting, etc.), user interaction elements (displays, buttons, switches, etc.). Furthermore, illuminated/illuminable or backlit/backlight symbols (warning symbols, status indicators, etc.), emblems (coats of arms, manufacturer symbols, logos, vehicle model and/or series designations, etc.), seams, imitation seams (e.g. decorative seams, functional seams, cross seams, etc.), gemstones or imitation gemstones, as well as other functional decorations are conceivable.

According to the present disclosure, a method for producing a decorative element is proposed, whereby the decorative element has one or more functional bodies. Such a functional body is described in more detail below. The decorative element is intended for a motor vehicle such as a passenger car, and in particular for the interior of a motor vehicle. The method according to the present disclosure—especially the filling tool according to the present disclosure—is used for production. In other words, the decorative element according to the present disclosure is a product that was/is produced by means of the method according to the present disclosure and/or by means of the filling tool according to the present disclosure. The steps involved in the method for producing the decorative element are explained in more detail below and can run in a different order than the order described. Furthermore, the steps can at least partially overlap in time, or run simultaneously, at least in part. In other words: First, the individual steps of the method are set out and their order emerges in connection with the description of the possible examples. The order of the steps may differ from one potential example to another. In this respect, the ordinals of the steps used in the description may not indicate a sequence of the steps, but primarily serve to provide a structured description.

An initial step in the process provides a decorative cut-out with an insertion opening and one or more functional bodies. The decorative cut-out has a visible side and an adhesive side, whereby these two sides are spaced apart from one another by a material thickness of the decorative cut-out and their surfaces are normally opposite one another. The decorative cut-out in particular is flat material made of a textile or a textile-like material, or of leather and/or artificial leather. Furthermore, film or rigid structures (for example plates) made of these or other materials are conceivable, such as, for example, TPO (thermoplastic polyolefins), etc. Natural, renewable and/or synthetic leather substitutes (apple leather, mushroom leather, eucalyptus leather, pineapple leather etc.), hot-stamped or non-hot-stamped textiles, glass or imitation glass, metallic materials, ceramics, wood, plastics etc., can also be used as materials for the decorative cut-out. In addition, a material structure made of a mixed material is conceivable, to, for example, have one or more of the aforementioned materials. If two or more decorative cuts are used, they can be made of the same or different material. The respective material can be transparent or non-transparent and/or permeable or non-permeable to acoustic waves. The insertion opening can be formed between opposing and spaced-apart edges of two decorative cuts or of a decorative cut-out including at least two parts. At least one of the edges can be straight or shaped according to an odd curve. The visible side can be smooth/flat, or structured, for example have concave and/or convex or 3D-shaped elements. Furthermore, the visible side can have one or more different surface structures, each of which has even and/or uneven edges, etc. The surface structures and the decorative cut can be formed integrally with one another. Alternatively, the surface structure formations and the decorative cut can be joined together in a force-fitting, form-fitting and/or material-fitting manner. Furthermore, at least one of the surface structure formations can be produced by at least partially forming the decorative cut, for example by embossing, thermoforming, etc. It is also conceivable that one or more of the surface structures are formed on/at the visible side by means of generative manufacturing, such as 3D printing, and are consequently connected to it. The decorative cut and the surface structure formations can thus form one and the same semi-finished product. The respective surface structure formation can be smooth/flat or structured and can itself have concave and/or convex or 3D-shaped elements.

The (respective) functional body is, for example, a rigid, semi-rigid or soft body that is connected to the decorative cut to produce the decorative element. The functional body has a visible side and a back side. The decorative cut has at least one insertion opening corresponding to the functional body, which is at least sized such that the functional body can be at least partially inserted into this insertion opening. In other words, the insertion opening at the least is large enough to allow the functional body to be inserted into the insertion opening precisely. The insertion opening can also be made larger so that the functional body can initially be loosely inserted into the insertion opening. The insertion opening has a support area on which the functional body is positioned so that it cannot fall through the insertion opening. The functional body can be permeable to light or at least to light that has a wavelength of approximately 380 nm (nanometers) to 780 nm. In other words, the functional body can be permeable to visible light. For instance, light can filter through holes or other material-free spaces in the functional body. Light can also filter directly through a material of the functional body, in which case the functional body is or will be made from a translucent material, at least partially in some areas. The functional bodies can be subsequently processed, for example by coating, painting, laminating, drilling, etc. Accordingly, the functional body can be designed, for example, into a ventilation grille or a ventilation duct element, so that the decorative element can be used as part of or in conjunction with an interior air conditioning system for a motor vehicle.

To carry out the method further, such as in a second step of the method, a filling tool is provided. The filling tool has a sealing unit that corresponds to the insertion opening of the decorative cut. The filling tool is therefore prepared by providing at least the sealing unit. In other words, the filling tool can be formed by the sealing unit.

The method has a further (for example third) step in which the decorative cut and the functional body are inserted into the filling tool. The functional body is inserted into the associated insertion opening so that an assembly is formed from the decorative cut and the functional body. This assembly is supported by the sealing unit. If the assembly is inserted into the filling tool, in particular into a working area of the filling tool, the assembly formed from the decorative cut and the functional body rests in/on the filling tool, in that the assembly rests—in particular directly or immediately—on the sealing unit. The decorative cut and the functional body are supported together by means of the sealing unit by being inserted into the filling tool. The decorative cut and the functional body can each rest directly on the sealing unit. If the functional body protrudes beyond the visible side of the decorative cut, the functional body dips into corresponding areas of the filling tool. The functional body can penetrate the sealing unit completely if desired.

In a further step of the process, which can be a fourth step, for example, a non-destructively removable and fluid-tight fixation is formed between the sealing unit and the assembly on the visible sides. The fluid-tight fixation, which can be removed without damage, is therefore formed between the sealing unit and the visible side of the decorative cut and between the sealing unit and the visible side of the functional body. Accordingly, when the fluid-tight fixation is removed, neither the visible side of the decorative cut nor the visible side of the functional body are damaged. The fluid-tight fixation can already be created by a weight force that acts between the assembly and the sealing unit due to the mass of the assembly. Furthermore, a sealing element, such as a sealing adhesive that can be removed without damage, can be used between the assembly or between the visible sides and the sealing unit.

In the process, the insertion opening is filled with a filling material (such as a polymer, a hot melt, a dispersion, etc.) in a fifth step. In this respect, the functional body already inserted into the insertion opening during filling is at least partially covered with the filling material, so that the functional body is at least partially embedded in the filling material during filling. This can provide for the filling material to be flexible, rigid or reversibly elastically bendable before being introduced into the insertion opening, or into areas of the insertion opening not occupied by the functional body, having been pressed into a shape using non-cutting and/or machining manufacturing processes that correspond to the shape of the areas of the insertion opening not occupied by the functional body. It is also conceivable that the filling material is brought into a liquid or at least paste state and then introduced into the insertion opening in order to harden therein. For filling, the filling material can be rolled onto the lamination side of an application material layer using a transfer roller device, for example. On the one hand, the functional opening is filled with the filling material as it flows into the functional opening, especially if the filling material is applied to the lamination side in liquid/paste form. On the other hand, the lamination side of the application material layer is coated with the filling material away from the functional opening by rolling on the filling material. The filling material can therefore alternatively or additionally be a coating material.

In general, the filling material can at the least have adhesive properties or be an adhesive. Accordingly, the filling material can also be used to create a final bond between the application material layer and the decorative cut.

On the one hand, this process allows the decorative element to be manufactured especially efficiently. On the other hand, the decorative element manufactured using this process is particularly easy to laminate and can therefore be laminated onto a dimensionally stable support structure particularly precisely, in particular without the formation of wrinkles. The carrier structure is an injection-molded carrier which is coated with a layer of a soft component (for example textile, spacer fabric, foam, etc.) or at least partially comprises thereof. The decorative element can be laminated onto this layer. The carrier structure can be shaped three-dimensionally, present a flat shape, or in particular, a wavy and/or single-curved or multiply curved shape.

Furthermore, a simple possibility has been created to join together plane material, which is particularly flat compared to the functional body, and the functional body, which is particularly thick compared to the plane material or the decorative cut, without any gaps. This reduces surface gaps and results in a particularly pleasing, organic design. By integrating the functional body or functional bodies, these can be optimally and ergonomically aligned in terms of function (for example for a user of the vehicle) without having to deviate from a main design process or from a selected design language in the interior of the vehicle. An electrical/electronic component, such as a sensor, a light-guiding element, a light source, etc., can be integrated and fixed using the functional body, i.e. for example in the functional body. The functional body, in one example, protrudes from the finished decorative element.

By fixing the sealing unit and the visible sides of the assembly to one another for filling the insertion opening with the filling material, such that the insertion opening is fluidically sealed by the sealing element on the visible side of the assembly against the leakage of filling material onto the visible side(s), it is provided that no filling material gets onto the visible side of the decorative cut, from which it would have to be removed again after filling. The process therefore produces a particularly clean decorative element that can be laminated onto the carrier structure as intended without a cleaning step beforehand. This again contributes to a particularly efficient manufacturing process.

In an additional development of the process, a suction device is used which is provided, for example, as a component of the filling tool. The suction device, such as a blower, is used to create or at least strengthen the fluid-tight fixation between the sealing unit and the visible side of the decorative cut-out and between the sealing unit and the visible side of the functional body. To do this, the suction device generates a negative pressure (pressure that is significantly lower than atmospheric pressure under normal conditions, such as a rough vacuum) on the respective visible side. In this way, the assembly is sucked onto the sealing unit, whereby the sealing effect of the fluid-tight fixation is strengthened. If a paste or liquid filling material is then used for filling, it is guaranteed that this does not get onto the visible side of the decorative cut-out and/or the functional body in an undesirable way, which would contaminate the decorative element.

In order to provide a particularly efficient processing temperature of the assembly and, as a result, a particularly tight fit of the assembly in/on the filling tool, a further example of the method provides for heating the filling tool using a heating device. In this respect, the filling tool can therefore comprise the heating device as a component. By heating the filling tool using the heating device, a flow of the filling material into the insertion opening can be encouraged-if the filling material is used in liquid or paste form—so that the insertion opening can be filled particularly efficiently with the filling material. Furthermore, heating the filling tool indirectly heats the inserted assembly, which further promotes efficient filling of the insertion opening. In addition, heating or warming the assembly has the advantageous effect of making the decorative cut more flexible, which contributes to the already mentioned tight fit of the assembly in/on the filling tool. If the decorative cut is designed to be wavy or curved as intended or has raised structural elements or the like, a temperature that is too low can lead to the decorative cut lifting off from the sealing unit in some areas, which would lead to an undesirable leakage of filling material onto the visible side.

In another example of the method, the filling material is provided as a filling material that is translucent in the fully reacted state, i.e. permeable to visible light. In the fully reacted or hardened state, the filling material can have a milky appearance, similar to frosted glass. This results in a diffusely distributed light emerging from the filling material when the filling material is illuminated in the desired manner. Alternatively, it is conceivable that the filling material is completely transparent in the fully reacted state, in particular true to the image. This opens up many new possibilities for integrating a lighting design, particularly technical and/or decorative lighting functions, into the interior of the vehicle by inserting the decorative element into the interior. Furthermore, the filling material can be light-tight, i.e. opaque to visible light, in the fully reacted state. The filling material is therefore inserted into the insertion opening and reacts there at the latest in the fully reacted state in which it is translucent or transparent, true-to-image transparent, or light-tight.

In this case, the hardened or reacted state may not mean that the filling material is rigid or brittle in the reacted state; rather, “hardened” or “reacted” are to be understood here as meaning that no further increase in strength is to be expected under normal conditions. Accordingly, the filling material can be flexible in its reacted state.

In order to fill the insertion opening with the filling material, a further development of the method provides for the filling material to be provided in at the very least a paste form, in particular a liquid state, so that a material-locking connection is established between the decorative cut and the filling material during filling or while filling the insertion opening. Furthermore, a material-locking connection is established between the filling material and the functional body so that the decorative cut and the functional body are materially connected to one another by means of the filling material. In general, the method or the decorative element can provide for the filling material to have at least the adhesive properties of an adhesive. Accordingly, an adhesive can be used as the filling material, for example. The adhesive, i.e. material-locking connection between the filling material and the decorative cut—and in particular between the filling material and the functional body—results in a particularly stable structure of the decorative element.

In addition, in the method—in a further example—an application material layer is provided which has an adhesive side and a covering side which are spaced apart from one another by a material thickness of the application material layer and whose surface are normally opposite one another. The adhesive side of the application material layer is glued at least to the adhesive side of the decorative cut. The application material layer can cover the insertion opening and consequently the functional body inserted into the insertion opening and/or be glued directly or indirectly to the functional body. In particular, the application material layer is a textile structure, a fleece or a film which is permeable to light, at least to visible light. For example, light can filter through mesh or other material-free spaces in the application material layer. Furthermore, it can be provided that the light filters directly through a material of the application material layer, in which case the application material layer is made of an at least partially translucent material. In another example, the application material layer is opaque. In any case, the application material layer can be coated to be light-conductive. The decorative cut is stabilized by the application material layer—especially during lamination—so that the decorative cut and any webs between functional bodies—even if these are particularly delicate, for example only a few millimeters or less than a millimeter wide—do not deform in an undesirable way.

In this context, a further example of the method provides for the application material layer to be glued to the decorative cut before the insertion opening is filled with the filling material. The insertion opening is then filled through the application material layer, for example through openings that penetrate the application material layer. The filling material thus acts as a reinforcing element for the connection between the application material layer and the decorative cut and/or the functional body, which again advantageously contributes to a particularly stable/long-lasting decorative element.

According to a further example, the application material layer is provided in a fluid-permeable manner and the filling material is introduced from the lamination side of the application material layer into the corresponding insertion opening by oversaturating the application material layer with the filling material, so that the filling material flows through the application material layer in the direction of the visible side of the decorative cut, whereby the filling material flows into the insertion opening while exiting the application material layer. To this end, so much liquid/paste filling material is brought into direct contact with the lamination side of the application material layer that the application material layer soaks up the filling material and subsequently becomes completely soaked at least in the area of the insertion opening, which leads to the filling material flowing through the application material layer into the functional opening. At the latest after flowing into the insertion opening, the filling material reacts, for example passively or by adding an activator or hardener, heat or other radiation, such as ultraviolet light, etc. In the reacted state, the filling material is, for example, hardened and in any case translucent.

This results in a particularly stable decorative element, and on the other hand, the process involves very little effort to fill the insertion opening with the filling material. This is because there is no need to separately form openings, for example by cutting them, in the application material layer. This means that particularly short cycle times can be maintained when producing the decorative element, which is particularly advantageous.

If, however, the application material is provided with such openings, or if one or more such openings are cut into the application material layer, an alternative procedure for filling the insertion opening with the filling material comes into consideration: in this case, the filling material is introduced into the insertion opening through the openings cut into the application material layer or formed in another way. In this way, a particularly efficient filling of the insertion opening is guaranteed.

To provide the decorative cut according to a further example, the insertion opening of the decorative cut for the functional body is formed in such a way that—when the functional body is inserted into the associated insertion opening—the gap is formed between the functional body and the decorative cut, which is filled with the filling material. This can be done in the same operation as filling the insertion opening with the filling material and/or in a further/separate filling operation. This gap is filled with the—possibly translucent—filling material, so that a filled light gap is formed through this gap. It is therefore conceivable, for example, to position the finished decorative element in the motor vehicle in front of a light source, so that when the light source is activated, light enters the filling material and exits it on the visible side.

In order to further increase the ability of the decorative element to be concealed, a further example of the method provides that a height compensation element be inserted on the adhesive side of the decorative cut before the insertion opening of the decorative cut is filled with the filling material. The thickness of the height compensation element is selected such that a rear side of the assembly corresponds to a flat (imaginary) plane. Two cases are conceivable which can occur individually or together on one and the same decorative element or on one and the same assembly: First, the rear side of the functional body is lower than the adhesive side of the decorative cut. The height compensation element is then placed on the rear side of the functional body. A height compensation element is used for this purpose, the thickness of which is sized such that a side of the height compensation element facing away from the rear side of the functional body which rests on the rear side of the functional body, and the adhesive side of the decorative cut end in a common flat (imaginary) plane. Secondly, the back of the functional body extends beyond the adhesive side of the decorative cut. The height compensation element is then placed on the adhesive side of the decorative cut. A height compensation element is used for this purpose, the thickness of which is such that the side of the height compensation element facing away from the back of the functional body, which rests on the adhesive side of the decorative cut, and the back of the functional body end in a common flat (imaginary) plane. This makes it easier, in particular, to place and bond the application material layer. The height compensation element can be made of a porous material and/or a material through which a fluid can flow. Alternatively, the height compensation element can be made of a dense or compact material. If two or more height compensation elements are used for the decorative element, they can be the same or different in terms of material, geometry and/or dimensions.

The present disclosure also relates to a filling tool that is used to produce the decorative element. The filling tool is therefore used as a means to produce the decorative element. The filling tool has at least the sealing unit, whereby an upper side of the sealing unit is formed by an upper side of a sealing layer of the sealing unit onto which the decorative cut is placed to produce the decorative element. This means that the sealing unit comprises the sealing layer. By means of the filling tool, it is advantageously possible to repeatedly align the functional body and the decorative cut with one another in an accurate position with very little effort. The filling tool therefore produces results with particularly high and consistent accuracy.

In a further development of the filling tool, it has a base body that has a connecting side via which the sealing unit can be connected or is connected to the base body. In this case, the filling tool is therefore designed in several parts, i.e. at least in two parts. The base body and the sealing unit are then two elements, bodies or parts manufactured separately from one another, which are connected to one another in a force-, form- and/or material-locking manner in a reversible, non-destructive manner to build the filling tool or to provide/prepare the filling tool. In particular, the fastening/connection of the sealing unit to the base body can be part of a set-up process for the filling tool. The ability to separate the base body and the sealing unit from one another in a non-destructive manner as intended makes the filling tool particularly easy and inexpensive to maintain. If the sealing unit or the base body is damaged, the sealing unit or the base body can be replaced particularly efficiently.

In a further example of the filling tool, the sealing unit that is connected or to be connected to the base body was selected from a range of sealing units. The range includes a large number of different and/or different sealing units, and the base body corresponds to the sealing units in the range. In this respect, the present disclosure further relates to a set that has the range of sealing units and at least one base body or a range of base bodies comprising different/various base bodies. The possibility of using different sealing units and/or different base bodies to manufacture decorative elements means that a particularly large number of variants of decorative elements can be produced.

In a further example of the filling tool, it is constructed of several layers. The filling tool therefore has at least two layers, one of which is the sealing layer. In particular, the filling tool is therefore constructed from the following layers: the sealing layer, a soft layer, a carrier layer.

This provides a modular structure for the sealing unit, whereby its layers can be separated from one another as intended, for example in order to exchange one or more of the layers for other layer variations. This is advantageous in terms of a particularly versatile or variable use of the filling tool or its sealing unit, in order to be able to produce different decorative element variants. In this case, the same filling tool is used in addition to the possibly varied sealing element.

When the decorative element is manufactured, the sealing layer faces the visible side of the decorative cut. This means that during the process the decorative cut lies directly on the sealing layer, with the decorative cut lying directly on or against the top of the sealing layer. In this respect, the top of the sealing layer forms a sealing side of the sealing layer, in particular of the filling tool. The sealing layer is made, for example, from a reversibly elastically malleable plastic, rubber, etc. The sealing layer can also be an adhesive layer at least in some areas or have an adhesive layer, so that the decorative cut and/or the functional body can be temporarily (i.e. in particular only during the manufacture of the decorative element) tightly glued to the sealing side or top of the filling tool. This bond between the sealing side or top and the decorative cut and/or the functional body is designed to be removable without causing any damage.

The soft layer and the sealing layer are connected to one another. The soft layer has a lower hardness than the sealing layer and can therefore be pressed deeper than the sealing layer at the same pressure. The soft layer can, for example, be a foam material that is reversibly elastically deformable. It can also be provided that the soft layer is thicker than the sealing layer. It can also be provided that the sealing layer and the soft layer are formed together as an integral component. For example, the soft layer can be surrounded by the sealing layer on the outer circumference, so that the soft layer forms a core of the integral component, with the sealing layer forming a jacket of the integral component.

The carrier layer, for example, is made from a metallic material such as a metal or a metal alloy, a plastic such as a polymer, etc. In particular, a material is used that conducts heat particularly efficiently, i.e. has a particularly advantageous thermal conductivity coefficient. In conjunction with the heating device—this supports the warming or heating of the filling tool and its base body in particular. The sealing layer and the soft layer are fixed to the carrier layer, so that the sealing layer and the soft layer are supported together by the carrier layer. For this purpose, a force-fitting, form-fitting and/or material-fitting connection is provided between the carrier layer and the soft layer.

The sealing layer and the carrier layer or the soft layer and the carrier layer are connected or fixed to one another via force-fitting, form-fitting and/or material-fitting. In a layered or stacked arrangement of the soft layer and the sealing layer, it is provided that the sealing layer is connected to the carrier layer via the soft layer. In the case of the integral component, it is provided that the carrier layer and a jacket portion of the sealing layer facing the carrier layer are connected to one another. In particular, an anti-slip device is arranged between the carrier layer and the soft layer or between the carrier layer and the casing portion facing the carrier layer, so that slipping of the top/sealing side of the sealing layer in relation to the carrier layer is inhibited. The casing portion facing the carrier layer or the soft layer is connected to the carrier layer, for example by means of a clamp connection, tongue and groove connection, etc.

In particular, a double-sided adhesive layer is provided for connecting or fixing the soft layer and the carrier layer to one another. The carrier layer and the soft layer are thus attached to one another by means of the double-sided adhesive layer, which can be a double-sided adhesive tape, for example. A first adhesive side of the double-sided adhesive layer facing the soft layer and connected or bonded to it can provide a stronger adhesive force than a second adhesive side of the double-sided adhesive layer facing the carrier layer and connected or bonded to it. This allows the layer composite to be dissolved particularly efficiently, for example for replacement, maintenance and/or repair work on the sealing unit, whereby the sealing layer, the soft layer and the double-sided adhesive layer then remain connected to one another and can be removed together from the carrier layer. In the event that the soft layer and the sealing layer together form the integral component, the carrier layer and the part of the casing of the sealing layer facing the carrier layer are connected by means of the double-sided adhesive layer.

The soft layer, the double-sided adhesive layer, the carrier layer and/or any adhesive used between the soft layer and the sealing layer—at least in some areas—are/is particularly porous and thus permeable to air. Optionally, the soft layer, the double-sided adhesive layer, the carrier layer and/or any adhesive used between the soft layer and the sealing layer can have openings (for example holes and/or incisions) that completely and/or partially penetrate the corresponding layer. This allows air to flow through the openings or through the soft layer which advantageously contributes to efficient venting of the filling tool and its base body in particular.

In a further example, the filling tool has an auxiliary filling opening arrangement which comprises one or more auxiliary filling openings. When the insertion opening is filled with the filling material, air can enter the auxiliary filling opening arrangement, i.e. into at least one auxiliary filling opening, and this air is displaced by the filling material during filling. The auxiliary filling opening arrangement can be formed, for example, by one or more of the openings already mentioned above, which at least partially penetrate the soft layer, the double-adhesive layer, the carrier layer and/or the adhesive possibly used between the soft layer and the sealing layer. Filling the insertion opening with the filling material—in particular provided in liquid form—is especially efficient thanks to the auxiliary filling opening arrangement, i.e. through the corresponding auxiliary filling openings, since the air which is displaced by the filling material flowing into the insertion opening escapes into one or more of the auxiliary filling openings. The air displaced by the filling material can be vented or escaped, for example, along abutting or adjacent surfaces of the individual layers (sealing layer, soft layer, carrier layer) or through the material of the decorative cut itself in the direction of the at least one auxiliary filling opening. This means that the insertion opening is filled cleanly and precisely with the filling material without any air pockets, cavities, edge gaps between the filling material and the decorative cut, etc., and the filling process is particularly efficient. Furthermore, a particularly stable or reliable material bond between the decorative cut and the filling material or between the filling material and the functional body is promoted.

A further example of the filling tool, of the auxiliary filling opening arrangement in particular, provides a (first) blind hole formed in the base body as a (first) auxiliary filling opening of the auxiliary filling opening arrangement, which opens/ends on the connection side of the base body. In a further possible example of the filling tool, in connection with the auxiliary filling opening arrangement, it is provided that the auxiliary filling opening arrangement has, alternatively or in addition to the first blind hole, for example as a further (second) auxiliary filling opening, a (second) blind hole that is formed in the sealing unit and opens/ends on the top/sealing side of the sealing unit. A bottom of the second blind hole or the second auxiliary filling opening can end in the sealing layer, in the soft layer, in the double-sided adhesive layer or in the carrier layer.

When the insertion opening is filled with the filling material, the air displaced thereby flows into the respective blind hole, whereby the air pressure in the respective blind hole increases. The air flows through the soft layer, the double-sided adhesive layer and/or the adhesive possibly used between the soft layer and the sealing layer, which are each porous/permeable to air at least in the area of the first blind hole. This also applies to the third and fourth auxiliary filling openings, which are described below. This results in a particularly clean visible side of the decorative cut-out or decorative element, since the filling material can penetrate the insertion opening particularly efficiently.

In order to enable the air displaced by the inflowing filling material when filling the insertion opening to escape particularly efficiently from the insertion opening, the filling tool or the auxiliary filling opening arrangement in another example, for example as a further (third) auxiliary filling opening, has a (first) hole that completely penetrates the carrier layer. Alternatively, or additionally, for example as a further (fourth) auxiliary filling opening, the auxiliary filling opening arrangement in an additional development has a further (second) hole that completely penetrates the sealing unit. In other words: the second hole or the fourth auxiliary filling opening extends completely through the layers of the sealing unit in such a way that the top side of the sealing layer and a bottom side of the carrier layer are seamlessly connected to one another via the second hole. When the insertion opening is filled with the filling material, the displaced air can therefore flow to the underside of the carrier layer and further out of the carrier layer and consequently out of the sealing unit. At least in connection with the third and fourth auxiliary filling openings, it is provided that the air flows out of the filling tool into the surroundings of the filling tool, i.e. into the atmosphere as it flows out of the sealing unit. This is advantageous in that the displaced air is not compressed by the filling material, whereby resistance to the flow of the filling material into the insertion opening is particularly low.

The auxiliary filling opening arrangement has—individually or in groups—at least one first auxiliary filling opening and/or at least one second auxiliary filling opening and/or at least one third auxiliary filling opening and/or at least one fourth auxiliary filling opening.

In another possible example, the filling tool comprises a ring element that is embedded flush into the sealing unit and is flush with its top side, the ring element having a different hardness, for example shore hardness, than the top side of the sealing unit. The entire top side, i.e. the entire sealing side, of the sealing unit is in this case partially formed by an upper side of the ring element. The ring element, which can also be referred to as an insert element, is for example made of a different material than the sealing layer. By way of example only, the sealing layer or the sealing unit, apart from the ring/insert element, can have a shore hardness value of A, whereas the ring/insert element can have a shore hardness value of D. In this way, different hardness ranges can be formed on the upper side of the sealing unit, which contribute to a particularly efficient filling of the insertion opening with the filling material and consequently to a particularly advantageous quality of the visible side of the decorative element.

In general, the openings described here (in particular for the insertion opening, the opening of the application material layer, the respective opening through the sealing layer, the soft layer, the double-sided adhesive layer, the carrier layer and/or the adhesive possibly inserted between the soft layer and the sealing layer, the respective auxiliary filling opening of the auxiliary filling opening arrangement) and for the ring element can have a hollow circular cylindrical cross-section, but do not have to. Oval, elliptical and/or polygonal cross-sectional shapes are just as conceivable for the respective opening or for the ring element. The respective opening can have been subsequently formed in the corresponding element without cutting or by cutting (for example by drilling, milling, cutting, laser cutting, punching or other perforating) or can have been created during the manufacture of the corresponding element—for example during the original molding of the element.

The decorative element according to the present disclosure is intended for a motor vehicle and its interior in particular. The decorative element is produced using a method according to the above description or using a filling tool according to the above description and has at least one functional body. In the intended installation position, i.e. when the decorative element has been used as intended in the interior of the motor vehicle, the visible side of the decorative cut and the visible side of the functional body face into the interior of the motor vehicle, so that an occupant of the motor vehicle sees the visible sides when looking at the decorative cut. The adhesive side of the decorative cut and the back of the functional body face away from the interior.

The decorative element can generally be laminated onto the dimensionally stable support structure using hard lamination, i.e. directly. The decorative element can also be laminated onto the support structure using soft lamination, i.e. using an intermediate layer between the decorative element and the dimensionally stable support structure. The intermediate layer can be a flat textile or a spacer textile, for example. Nonwoven and/or foam structures can be used. The intermediate layer can be translucent or transparent, or image-true transparent, or light-tight, in whole or in part. The intermediate layer can also be a light source or have a light source. For example, one or more lamps can be embedded in the material of the intermediate layer, attached to an outer surface of the intermediate layer, etc.

The respective functional body can be recessed into the visible side of the decorative cut or protrude from the visible side or end at the same height as the visible side, or be flush with the visible side. The respective functional body can be completely penetrated by material or can be designed with a chamber (i.e. hollow or similar to a housing with a housing chamber). In any case, the material of the functional body can be translucent, i.e. light-permeable, at least in some areas, or—in particular true to the image—transparent. If the functional body has the chamber, the electrical or electronic component can be housed in it, such as a light source, etc. Furthermore, the electrical/electronic component can form a part of the functional body. It is also conceivable that the functional body—before or after the decorative element has been produced according to the above method—is machined and/or non-machined in order to give it a final shape. The functional body, in particular its housing, can thus be designed as a light guide at least in some areas, so that the light source, i.e. one or more of the light sources of the light source, can be coupled to one or more of the outer surfaces of the functional body. For a possible transmission of electromagnetic waves (radar waves, etc.) from the functional body, in particular from the chamber, and/or for a possible reception of such waves, the housing or the material of the functional body can be designed to be permeable to this type of wave. For this purpose, the material of the functional body can be made of a glass fiber-filled polycarbonate (PC), for example. Furthermore, to support the transmission/reception of the waves, the functional body can have a dome-like portion or be designed as a dome overall.

For example, the decorative element is part of an interior lighting system. For this purpose, the decorative element then has at least one functional body, which is at least partially/regionally designed as a light exit element. In this case, the motor vehicle has a light source from which visible light is coupled out in an activated state. The light source and the decorative element and/or the functional body are aligned with one another or are connected to one another in a light-conducting manner directly or indirectly (for example by means of a light-conducting device) in such a way that the light coupled out from the light source and/or the light-conducting element filters through the functional body and in this way shines into the interior of the motor vehicle.

The light source generally has one or more illuminants and is designed in particular to emit so-called RGB lighting. Accordingly, the light source is in particular an RGB light source. Examples of the respective illuminants that can form the light source individually or at least in groups are: an incandescent lamp; a light-emitting diode (LED), in particular an organic LED (OLED); an LED chain or an LED strip.

A (in particular light-conducting) textile structure into which one or more illuminants is/are incorporated. In particular, this textile structure can be the application material layer that has the illuminant(s) at least in the functional opening area.

The light-guiding device has one or more light-guiding elements, for example an LED strip or an LED chain, etc. Examples of the respective light-guiding element, which can at least partially form the light-guiding device individually or at least in groups, are:

A surface light guide, for example made of polycarbonate, polymethyl methacrylate or another plastic suitable for light guidance. Several light sources of the light source (in one example several LEDs) are arranged on the narrow sides of the surface light guide. The light is introduced, for example, into a side plate or into a dimensionally stable injection-molded laminated carrier.

A light guide cord into which the generated light is introduced via a coupled light source (in one example an LED).

A flat textile into which light guide threads are incorporated. This lies between the carrier structure and the decorative element laminated onto it.

A textile structure into which one or more light guide elements is/are incorporated. In particular, this textile structure can be the application material layer which has the illuminant(s) and/or one or more of the light-guiding elements at least in the functional opening area.

As explained, a gap filled with the filling material, in particular poured out, can be formed between the functional body and the decorative cut, which acts as a filled light gap. Due to the (in particular milky) translucency of the filling material, at least in the area of the light gap, an advantageously diffuse light image is created around the functional body, which can be used efficiently for ambient lighting purposes, for example. The filling material or coating material in conjunction with a translucent or opaque application material layer thus acts as a light-conducting layer, for example as a light-conducting element or as a light-conducting layer.

Alternatively, or additionally, the decorative element can be part of a loudspeaker system, in particular a loudspeaker housing, in the interior of the motor vehicle, for example arranged as a covering over a loudspeaker. For this purpose, the decorative element then has at least one sound opening that extends through the decorative cut or through the functional body.

Further advantages, features and details of the present disclosure can be found in the following description of possible examples and from the drawing. The features and combinations of features mentioned above in the description as well as the features and combinations of features shown below in the description of the figures and/or in the figures alone can be used not only in the combination specified in each case, but also in other combinations or on their own, without departing from the scope of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic partial sectional view of an assembly including a decorative blank and a functional body, whereby the assembly is inserted into a filling tool and one example of the functional body is shown in each half of the image according to the present disclosure;

FIG. 2 is a schematic partial sectional view of the assembly inserted into the filling tool, showing two further examples of the functional body according to the present disclosure;

FIG. 3 is a schematic partial sectional view of the assembly inserted into the filling tool, showing two further possible examples of the functional body according to the present disclosure;

FIG. 4 is a schematic view of the assembly, whereby an insertion opening is filled with a filling material flowing through an application material layer according to the present disclosure;

FIG. 5 is a schematic view of the assembly, whereby the insertion opening is filled with the filling material which flows into the insertion opening through an opening in the application material layer according to the present disclosure;

FIG. 6 is a schematic view of the filling tool, which has a base body and a sealing unit according to the present disclosure;

FIG. 7 is a schematic view of several sealing units that are part of a range of different sealing units according to the present disclosure;

FIG. 8 a schematic partial sectional view of a sealing unit to produce a decorative element having a hot stamping area according to the present disclosure; and

FIG. 9 is a schematic sectional view of the sealing unit having an auxiliary filling opening arrangement according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Identical and functionally identical elements are provided with the same reference numerals in the figures. A method and a filling tool 1 for producing a decorative element 2 for a motor vehicle as well as the decorative element 2 itself are set out in a joint description below.

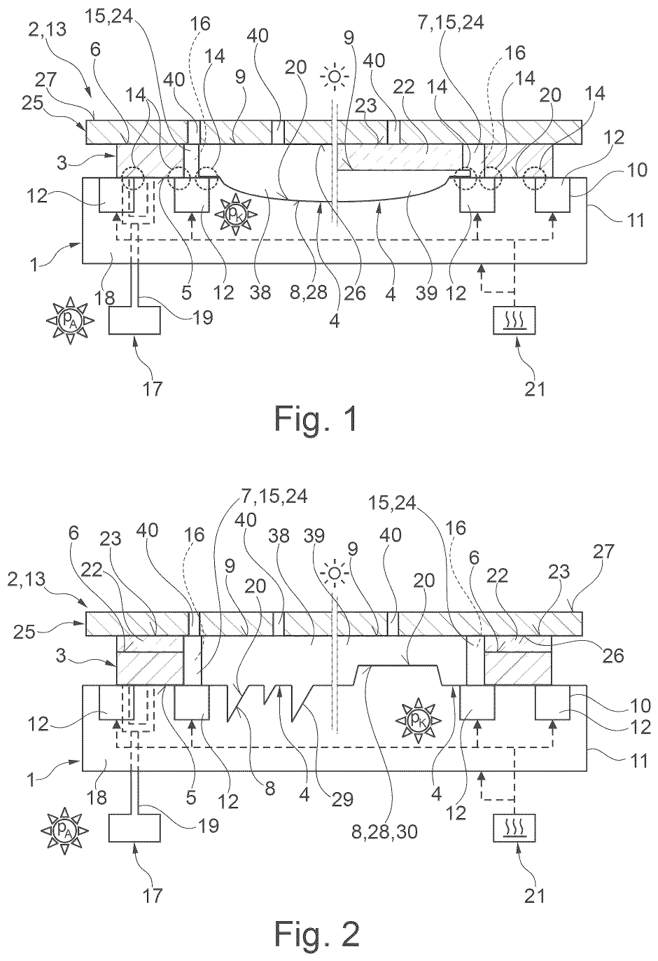

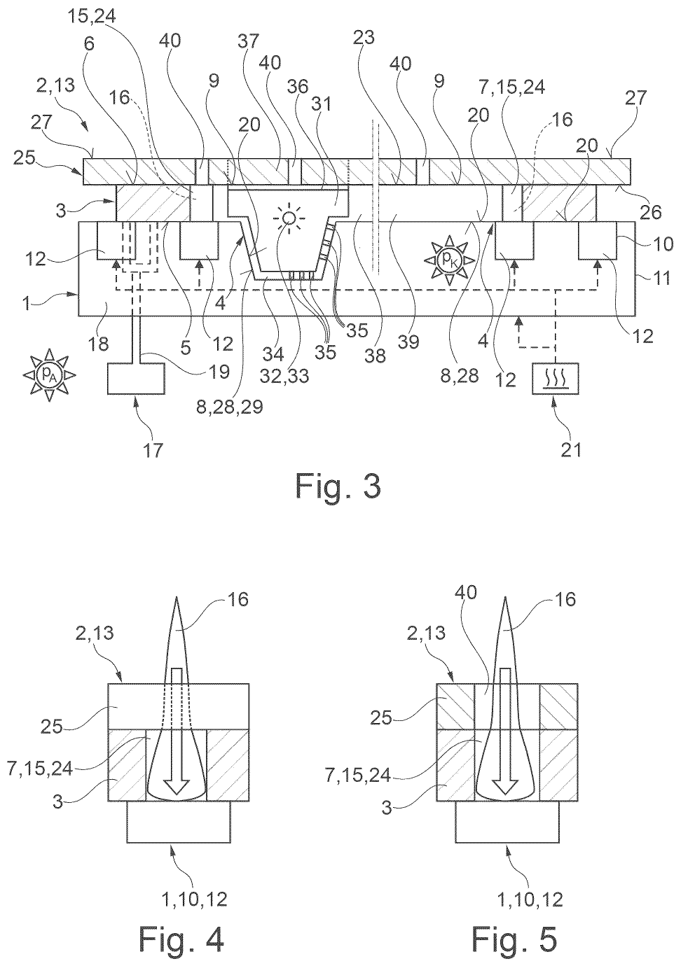

To this end, FIG. 1, FIG. 2 and FIG. 3 each show a schematic view of a decorative cut 3 and a functional body 4, which are provided in a first step of the method for producing the decorative element 2. It is conceivable that more than one functional body 4 is provided, i.e. that one and the same decorative elements can have two or more functional bodies 4. For example, only decorative cut 3 is made of a leather, or leather-like material and is therefore flexible or pliable. Decorative cut 3 has a visible side 5 and an adhesive side 6, which are opposite one another and spaced apart from one another by a material thickness of the decorative cut 3. Decorative cut 3 also has an insertion opening 7 or more insertion openings 7, whereby the respective insertion opening 7 corresponds to the functional body 4 or the functional bodies 4. The respective functional body 4 has a visible side 8 and a back 9.

Filling tool 1 is also provided or prepared. Filling tool 1 has a sealing unit 10, which in the present example is inserted into the base body 11 of the filling tool 1. Sealing unit 10 corresponds to the insertion opening 7 of decorative cut 3.

Decorative cut 3 is then inserted into filling tool 1, as shown in FIGS. 1 to 3. Before, after or during the arrangement of the decorative cut 3 in the filling tool 1 or on the Sealing unit 10, the functional body 4 is inserted into the insertion opening 7 of decorative cut 3. This initially forms a loose assembly 13 from the decorative cut 3 and the functional body 4. Ultimately, when the decorative cut 3 and functional body 4 are placed together in the filling tool, assembly 13 is supported by filling tool 1, in this case by sealing unit 10, since assembly 13 rests on sealing unit 10.

The inherent mass of assembly 13 resting on sealing unit 10 already creates a fluid-tight fixation 14 between sealing unit 10 and assembly 13, which is indicated in FIG. 1 by dashed circles. The fluid-tight fixation 14 can be removed while inhibiting damage, for example by lifting assembly 13 off sealing unit 10. Fixation 14 is therefore created between the sealing elements 12 and the visible sides 5, 8 for the further process. For reasons of clarity, fixation 14 is only indicated in FIG. 1.

The insertion opening 7, i.e. at least one insertion opening area 15 that is not occupied by the functional body 4 inserted into the insertion opening 7, is filled with a filling material 16 that is brought into an at least paste, in this case at least approximately liquid state for filling the insertion opening 7 or is already provided in this state. This means that when the insertion opening 7 is filled, a material connection is produced between the decorative cut 3 and the filling material 16, in particular by the filling material 16 and a material of the decorative cut 3 being connected to one another, for example by merging into one another. As a result, assembly 13 and consequently the decorative element 2, which emerges from assembly 13 in the further process, is stabilized or reinforced by filling with the filling material 16. The filling material 16 has adhesive properties of an adhesive or is an adhesive. The filling material 16 is, at least in its fully reacted state, translucent, i.e. permeable to visible light, or transparent, in particular true-to-image transparent, or opaque or light-tight. After the filling material 16 has fully reacted, there are no areas on the visible side 5, i.e. on the visible side 5 of the decorative element 2, or on its back (i.e. on the visible side 8 of the functional body 4, on the laminated side 27 of the application material layer 25, etc.) where a user of the decorative element 2, such as a fitter who installs the decorative element 2, can inadvertently stick. Instead, a particularly pleasing, in particular haptically pleasant surface is produced, even in areas in which part of the outer surface of the decorative element 2 is formed by the filling material 16.

For a reliable fixation 14, a suction device 17 is provided in the present case, via which a negative pressure, in one example, a rough vacuum, is generated between sealing unit 10 and the decorative cut 3 and/or the functional body 4, whereby assembly 13 is sucked in the direction of sealing unit 10. The suction device 17 can be a component of filling tool 1 or a suction device formed separately from filling tool 1. As shown in FIGS. 1 to 3, a hollow base body chamber 18 can be vented via the suction device 17, so that a pressure pK in the base body chamber 18 is lower than an atmospheric pressure pA that prevails in the vicinity of the base body chamber 18, in particular in the vicinity of filling tool 1. A pipe and/or hose system 19 of the suction device 17 can, alternatively or in addition to the connection to the base body chamber 18,—as shown in dashed lines in FIG. 1, FIG. 2 and FIG. 3—penetrate one or more of the sealing elements 12 and/or through the base body 11. The pipe and/or hose system 19 ends/leaves on an upper side 20 or sealing side 20 of sealing unit 10. Furthermore, the suction device 14 can have two or more separate vacuum circuits for providing a corresponding number of vacuums. For example, a different vacuum can be used to fix the functional body 4 than for the simultaneous fixing of the decorative cut 3.

In order to provide, for example, particularly efficient flow behavior of the filling material 16 and/or to create or maintain a suppleness that is advantageous for processing assembly 13, a heating device 21 is provided in the present case. This can be a component of filling tool 1 or a heating device designed separately from filling tool 1. The sealing side 20 of sealing unit 10 can be heated by means of the heating device 21, in the present case by heating one or more of the sealing elements 12 by means of the heating device 21, i.e. by heating them during the process. Alternatively or additionally, the base body 11 of filling tool 1 can be heated or warmed by means of the heating device 21, so that sealing unit 10 connected to the base body 11 and consequently assembly 13 resting on it can be heated or are heated indirectly.

The back 9 and the adhesive side 6 can lie in a common plane (see FIG. 1, left half of the image, and FIG. 3). Furthermore, the back 9 and the adhesive side 6 can fall apart, as shown in FIG. 1, right half of the image, or in FIG. 2, both halves. If this is the case, a height compensation element 22 is inserted before the insertion opening 7 or the insertion area 15 is filled with the filling material 16. According to the illustration in the right half of FIG. 1, the height compensation element 22 is placed directly on the back 9 of the functional body 4 if the back 9 of the functional body 4 is lower than the adhesive side 6 of the decorative cut 3. The height compensation element 22 is designed to be so thick that a side 23 of the height compensation element 22 facing away from the back 9 of the functional body 4, which rests on the back 9 of the functional body 4, and the adhesive side 6 of the decorative cut 3 end in the common flat (imaginary) plane. As can be seen from FIG. 2, however, the back 9 of the functional body 4 can be higher than the adhesive side 6 of the decorative cut 3. The height compensation element 22 is then placed directly on the adhesive side 6. The height compensation element 22 is designed to be so thick that the side 23 of the height compensation element 22 facing away from the back 9 of the functional body 4, which rests on the adhesive side 6 of the decorative cut 3, and the back 9 of the functional body 4 end in the or another common flat (imaginary) plane.

In the present case, for example when the decorative cut 3 is provided, the insertion opening 7 is formed in such a way that—when the functional body 4 is inserted into the associated insertion opening 7—a gap 24 or more gap 24s are formed between functional body 4 and decorative cut 3, whereby the respective gap 24 is filled with the filling material 16. This can be done, for example, in the same operation as filling the insertion opening 7 with the filling material 16 and/or in a further/separate filling operation. As the filling material is translucent or light-permeable in its fully reacted state, a light gap or a light opening is formed from gap 24. Different gap shapes or gap arrangements can be implemented through gap 24, for example slotted gaps, ring gaps, frame-like gaps and/or a combination thereof.

For particularly advantageous laminating behavior, in the present example an application material layer 25 is also provided and added to assembly 13 by placing the application material layer 25 on the back 9 of the functional body 4 and on the adhesive side 6 of the decorative cut 3 and, if desired, in some areas on the side 23 of the height compensation element 22. Furthermore, the application material layer 25 is glued to the decorative cut 3, to the functional body 4 and/or to the height compensation element 22. In the present example, the application material layer 25 is made of a textile and is flexible or pliable, in particular to a similar or the same extent as the decorative cut 3. Furthermore, the application material layer 25 is permeable to light, i.e. translucent. This means that the application material layer 25 is permeable to light that has a wavelength of approximately 380 nm (nanometers) to approximately 780 nm. The application material layer 25 has an adhesive side 26 and a laminated side 27, which are opposite one another and spaced apart from one another by a material thickness of the application material layer 25. The adhesive sides 6, 25 are bonded together, whereby the application material layer 25 and the decorative cut 3 and/or the functional body and/or the height compensation element 22 are connected to one another, can take place before, during or after the insertion opening is filled with the filling material 16. The filling material 16 flows through the application material layer 25 and, if applicable, the height compensation element 22 (if it is designed to allow a fluid to flow through it).

A combination of FIGS. 1, 2 and 3 shows different design options for the functional body 4. For example, it can protrude from visible side 5 of the decorative cut 3 (see FIG. 1), i.e. protrude beyond the visible side 5. In the example in FIG. 1, the functional body 4 has a visible side structure 28 which, with respect to the visible side 5 of the decorative cut 3, is uniformly organically shaped and protrudes convexly from it. In FIG. 2, the left half of the image shows that the visible side structure 28 of the functional body 4 can just as well be designed according to a different shape. The visible side structure with elevations 29 is shown here as an example. The respective elevation 29 can, for example, be a polyhedral elevation 29 (i.e., for example, pyramidal, diamond-shaped, cuboid-shaped, cube-shaped, etc.). Alternatively, or additionally, the respective elevation 29 can be designed according to a straight or oblique cylinder with an oval, elliptical or circular base. Irregularly arranged or shaped, mixed elevations 29 that at least partially overlap one another are also conceivable.

From the right half of FIG. 2 it can be seen that the functional body 4 can be at least partially lower than the visible side 5 of the decorative cut 3. Accordingly, the visible side structure 28 in this case has at least one recessed surface section 30, whereby an elevation 29 or another type of elevation (not shown), such as a switching element, a button, a switch, etc., can protrude from the respective recessed surface section 30. The respective elevation can end below or above the level of the visible side 5 of the decorative cut 3. The elevation 29 and the recessed surface section 30 are therefore not mutually exclusive.

The respective functional body 4 can be completely penetrated by its material or can be formed with a chamber 31 (i.e. hollow, i.e. similar to a housing with a housing chamber). FIG. 3, left half of the image, shows such a possible design of the functional body 4, which has the chamber 31. An electrical or electronic component 32, shown here as an example as a light source 33, can be accommodated or arranged therein. In the present case, the material of the functional body 4 is translucent in any case if an element is arranged in chamber 21 by means of which light can be emitted, such as a light guide or the light source 33. For this purpose, wall 34 of functional body 4 surrounding or defining the chamber 31 can have material recess 35, such as holes through which light can filter.

In order to gain access to chamber 31, it can further be provided that the functional body has a cover element 36, by means of which the chamber 31 can be opened/closed. A corresponding portion 37 of the application material layer 25—if present—corresponds to the cover element 36 and can be pivoted or removed when the cover element 36 is opened or before the cover element 36 is opened so that the cover element 36 can be opened. The cover element 36 can in particular be opened/closed even when the insertion opening 7 has been filled with the filling material 16 and the filling material 16 has reacted. The cover element 36 can alternatively be formed by a wall of a hollow body, which can be completely or partially cut out after filling.

The functional body 4 can be made up of several parts, for example composed of at least two functional body parts 38, 39. Using the example of FIG. 3, this means that the functional body has two functional body parts 38, 39 that are connected to one another in a force-fitting, form-fitting and/or material-fitting manner. The functional body parts 38, 39 can be connected before, during or after the formation of assembly 13 and/or by filling the insertion opening 7 with the filling material 16. The functional body parts 38, 39 can be designed the same or differently.

FIG. 4 and FIG. 5 each show a schematic view of a section of assembly 13, whereby the insertion opening 7 (the functional body is not shown for the sake of clarity) is filled with the filling material 16. For this purpose, the filling material 16 is brought into an at least paste, in this case at least almost liquid state or is already provided in this state. This means that when the insertion opening 7 is filled, a material-locking connection is created at least between the decorative cut-out 3 and the filling material 16. Filling material 16 has the adhesive properties of an adhesive or is an adhesive.

FIG. 4 shows a schematic view of assembly 13, whereby the insertion opening 7 or the insertion opening area 15 not occupied by the functional body 4 is filled with the filling material 16, which flows through the application material layer 25. For this purpose, the application material layer 25 is provided in a fluid-permeable manner. The filling material 16 is then directly contacted with the lamination side 27, so that the at least approximately liquid filling material 16 can penetrate into the application material layer 25. With a constant inflow of filling material 16 in the direction of the lamination side 27, the application material layer 25 is saturated/flooded with filling material 16 until the application material layer 25 is oversaturated in the area of the insertion opening 7 to be filled. Due to the oversaturation, the filling material 16 flows out of the application material layer 25 on the adhesive side 26 and consequently into the insertion opening 7. The filling material 16 is thus introduced from the laminated side 27 of the application material layer 25 into the corresponding insertion opening 7, whereby the application material layer 25 is flowed through by the filling material 16 in the direction of the visible side 5 of the decorative cut 3 and in the direction of the visible side 8 of the functional body 4, whereby the filling material 16 flows into the insertion opening 7.

If an adhesive layer (not shown) is used between the application material layer 25 and the adhesive side 6 of the decorative cut 3 and/or the back 9 of the functional body 4, the filling material 16 is supersaturated and flows through the application material layer 25 and then the adhesive layer under the constant inflow on the lamination side 27, which at least in this case is designed or provided to be fluid-permeable at least in its fully reacted state. Due to the supersaturation, the filling material 16 flows out of the application material layer 25 on the adhesive side 27 and consequently into the adhesive layer. The filling material 16 then flows into the insertion opening 7 while emerging from the adhesive layer.

FIG. 5 shows an alternative for guiding the filling material 16 into the insertion opening 7. FIG. 5 shows a schematic view of assembly 13, whereby the insertion opening 7 is filled with the filling material 16, which flows into the insertion opening 7 through a through-opening 40 or more such through-openings 40 of the application material layer 25. Consequently, in this case the application material layer 25 was provided with or provided the through-opening 40 or the through-openings 40.

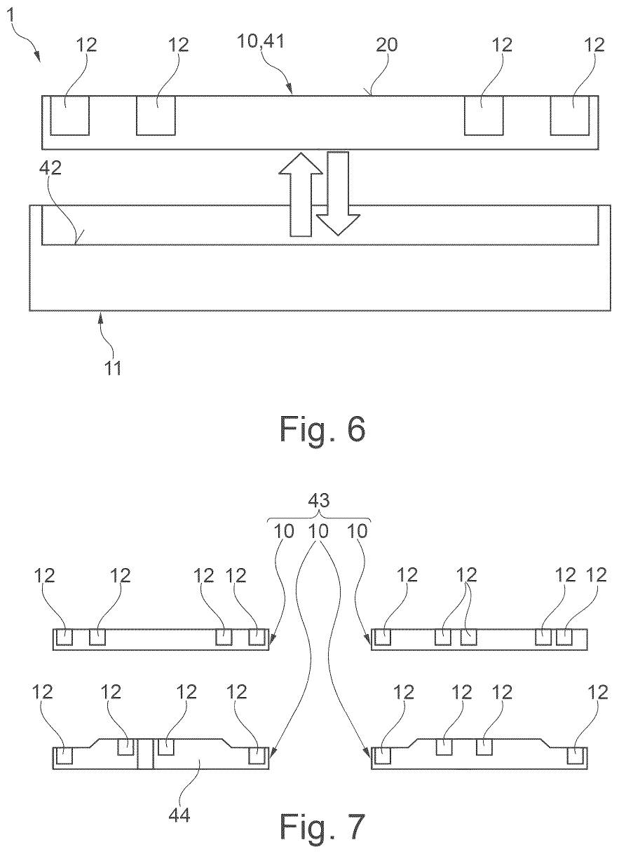

FIG. 6 shows a schematic view of filling tool 1, which in the present example has the base body 11 and sealing unit 10. Alternatively, filling tool 1 can be designed without the base body 11. Sealing unit 10 has a sealing layer 41, so that sealing unit 10 can be formed entirely or partially from the sealing layer 41. Base body 11 has a connecting side 42, via which sealing unit 10 and the base body 11 can be connected or are connected to one another in a force-fitting, form-fitting and/or material-fitting manner. As can also be seen from FIG. 6, sealing unit 10 and base body 11 are separate from one another.

FIG. 7 shows a schematic view of several sealing units 10 that are part of an assortment 43 of different sealing units 10. The respective sealing unit 10 of the assortment 43 corresponds to the base body 11, in particular to its connecting side 42, whereby the sealing units 10 of the assortment 43 can be exchanged for one another. The sealing units 10 of the assortment 43 are different from one another. In other words, the assortment 43 has at least two different and in particular different sealing units 10.

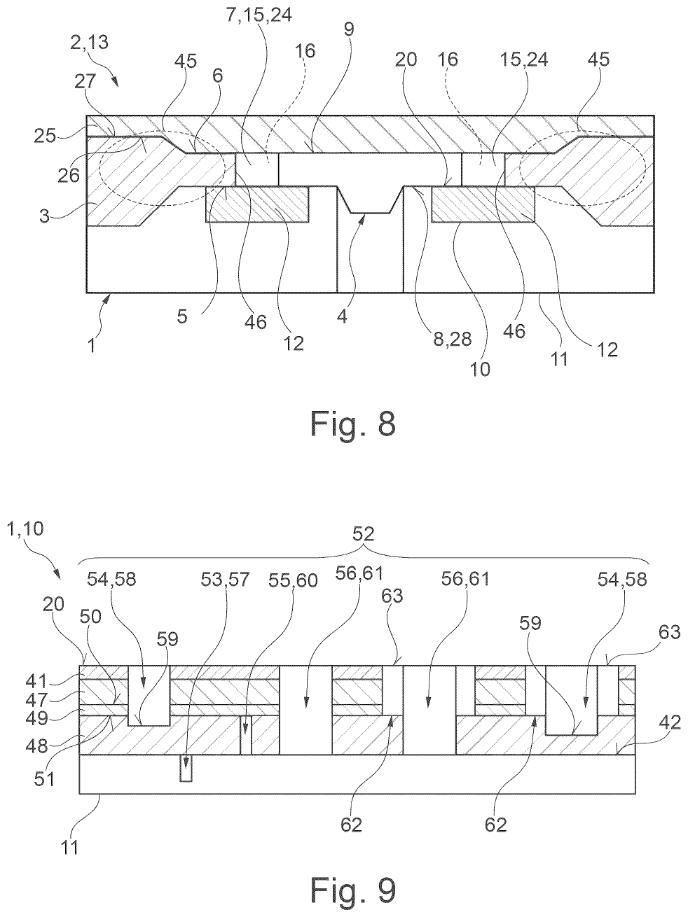

FIG. 8 shows a schematic and partially sectioned view of a sealing unit 44 to produce a decorative element 2, the decorative cut 3 of which has a thermally treated area, in this case a hot-stamping area 45. At least in this case, the decorative cut 3 is a textile and/or fiber structure into which the insertion opening has been cut or punched, etc. In order to inhibit the decorative cut 3 from fraying at the cutting points 46 and unwanted fibers from protruding into the insertion opening 7, the decorative cut 3 was/is hot-stamped. This reduces the thickness of the decorative cut 3 in the hot-stamping areas 45 compared to the thickness of the decorative cut 3 away from or outside the hot-stamping areas 45. It can be seen in the sealing unit 45 (see also FIG. 7) that it has a sealing or top side 20 designed to correspond with the hot-stamping areas 45. In this way, the decorative cut 3 rests particularly securely on sealing unit 10 for producing the decorative element 2.

From FIG. 9, which shows a schematic and sectional view of sealing unit 10, it can be seen that sealing unit 10 is constructed in multiple layers, in this case from the following layers: Sealing Layer 41; Soft Layer 47; Carrier Layer 48; and Double Adhesive Layer 49.

When producing the decorative element 2, the sealing layer 41 faces the visible side 5 of the decorative cut 3. During the process, the decorative cut 3 therefore lies directly on the sealing layer 41. The decorative cut 3 lies directly on or against the top side 20 of the sealing layer 41. The sealing layer 41 is formed, for example, from a reversibly elastically deformable plastic, rubber, etc. In the present case, the soft layer 47 and the sealing layer 41 are connected to one another. The soft layer 47 has a lower hardness, in particular Shore hardness, than the sealing layer 41 and can therefore be pressed deeper than the sealing layer 41 with the same pressure. The soft layer 47 can, for example, be a foam material that is reversibly elastically deformable. It can also be provided that the soft layer 47 is thicker than the sealing layer 41. The carrier layer 48—which is particularly rigid—is made, for example, from a metallic material, such as a metal or a metal alloy, from a plastic, for example a polymer, etc. In particular, a material is used that conducts heat particularly efficiently, i.e. has a particularly advantageous thermal conductivity coefficient. This supports—particularly in conjunction with the heating device 21—the warming or heating of filling tool 1, in particular its base body 11. The sealing layer 41 and the soft layer 47 are fixed to the carrier layer 48, so that the sealing layer 41 and the soft layer 47 are supported together by the carrier layer 48. For this purpose, a force-fit, form-fit and/or material-fit connection is provided between the carrier layer 48 and the soft layer 47. This connection is or will be formed, for example, by the double-sided adhesive layer 49, which can be a double-sided adhesive tape, for example. A first adhesive side 50 of the double-sided adhesive layer 49 facing the soft layer 47 and connected or bonded to it can provide a stronger adhesive force than a second adhesive side 51 of the double-sided adhesive layer 49 facing the carrier layer 48 and connected or bonded to it. The soft layer 47, the double-sided adhesive layer 49, the carrier layer 48 and/or an adhesive (not shown) possibly used between the soft layer and the sealing layer—in each case at least in some areas—are/is particularly porous and thus permeable to air.

In the present example, an auxiliary filling opening arrangement 52 is also provided, which has an auxiliary filling opening 53, 54, 55, 56 or more such auxiliary filling openings 53, 54, 55, 56. When the insertion opening 7 is filled with the filling material 16, air is displaced by the filling material 16, which can flow into one or more of the auxiliary filling openings 53, 54, 55, 56, making filling particularly efficient. The first auxiliary filling opening provided with the reference symbol 53 is a first blind hole 57, for example a blind hole bore, which was formed into the base body 11 starting from the connection side 42 of the latter. Accordingly, the first blind hole 57 or the first auxiliary filling opening 53 opens on the connection side 42. The auxiliary filling opening arrangement 52 comprises a further, second auxiliary filling opening 54, which is formed by a second blind hole 58, such as a blind hole bore, which is formed in sealing unit 10 and opens on its upper side 20. A bottom 59 of the second blind hole 58 lies in the soft layer 47, in the double-adhesive layer 49 or in the carrier layer 48. The second blind hole 58 or the second auxiliary filling opening 54 opens on the sealing side 20.

In the present example, the auxiliary filling opening arrangement 52 also has a third auxiliary filling opening, designated 55, which is designed here as a first through hole 60. This first through hole 60, such as a through bore, extends through the entire carrier layer 48. Furthermore, FIG. 9 shows that the auxiliary filling opening arrangement 52 also has a (second) through hole 61 as a further (fourth) auxiliary filling opening 56, which completely penetrates the entire sealing unit 10, i.e. the layers 41, 47, 49, 48.

Furthermore, FIG. 9 shows two ring elements 62 which are embedded in sealing unit 10, i.e. at least in the sealing layer 41, and are flush with the sealing side 20. The respective ring element 62, which can also be referred to as an insert element, has a different hardness, for example Shore hardness, than the top side 20 of sealing unit 10. The entire top or sealing side 20 of sealing unit 10 is in this case partially formed by a respective top side 63 of the ring element 63 or the ring elements 63. The ring element 63 is, for example, made of a different material than the sealing layer 41.

As already mentioned, FIGS. 1, 2 and 3 show the decorative element 2, which was produced by means of the method using filling tool 1 and has one or more functional bodies 4. The decorative element 2 is intended for an interior of a motor vehicle (not shown). When the decorative element 2 is installed as intended, it forms a component of the motor vehicle. The decorative element 2 is in particular an interior element, for example a covering element for the loudspeaker, a door panel, etc. or another cladding and/or covering element, for example for an instrument panel of the motor vehicle. The following can also be considered as decorative elements 2: an instrument panel, a center console, a roof liner, seats, headrests, seat cushions, upholstery elements, vehicle furniture, pillar cladding, etc. The visible side 5 of the decorative element 2, i.e. the visible side 5 of the decorative cut 3, faces into the interior, whereas a laminated side of the decorative element 2 formed by the laminated side 27 of the application material layer 25 (if present) or by the adhesive side 6 of the decorative cut 3 faces out of the interior 48.

The method, filling tool 1 and the decorative element 2 show a respective possibility of how a particularly versatile and highly functional decorative element can be provided as efficiently and with as little effort as possible.

In various examples, the present disclosure provides a filling tool 1 wherein the auxiliary filling opening arrangement 52 has, as an auxiliary filling opening 53, a blind hole 57 formed in the base body 11, which opens at the connecting side 42 of the base body 11. The filling tool 1 also includes the auxiliary filling opening arrangement 52 that has a blind hole 58 as a further or second auxiliary filling opening 54, which is formed in the sealing unit 10 and opens at the upper side 20 thereof. The filling tool 1 also includes the auxiliary filling opening arrangement 52 that has, as a second or further auxiliary filling opening 55, a through hole 60 which completely penetrates the carrier layer 48. The filling tool 1 also includes the auxiliary filling opening arrangement 52 that has, as a second or further auxiliary filling opening 56, a through hole 61 which completely penetrates the sealing unit 10.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for producing a decorative element with a functional body for a motor vehicle, the method comprising:
providing the functional body and a decorative cut, the functional body including a visible side and a back side, the decorative cut including a visible side, an adhesive side, and an insertion opening corresponding to the functional body;
providing a filling tool including a sealing unit that corresponds to the insertion opening of the decorative cut;
inserting the decorative cut into the filling tool and inserting the functional body into the insertion opening so that an assembly formed from the decorative cut and the functional body is supported via the sealing unit;
forming a non-destructively detachable and fluidically tight fixation between the sealing unit and the assembly on the visible side of the decorative cut and the visible side of the functional body; and
filling the insertion opening of the decorative cut with a filling material.

2. The method according to claim 1,
further comprising producing the non-destructively detachable and fluidically tight fixation between the sealing unit and the visible side of the decorative cut and between the sealing unit and the visible side of the functional body by generating a negative pressure on the visible side of at least one of the decorative cut and the functional body via a suction device.

3. The method according to claim 1, further comprising heating the filling tool via a heating device.

4. The method according to claim 1, wherein the filling material is translucent until the filling material has fully reacted.

5. The method according to claim 1, wherein the filling material for filling the insertion opening is provided in a liquid state, and the method further comprises establishing a material-locking connection between the decorative cut and the filling material when filling the insertion opening.

6. The method according to claim 1, further comprising providing an application material layer including an adhesive side and a laminating side, and the method further comprises gluing the adhesive side of the application material layer to the adhesive side of the decorative cut.

7. The method according to claim 6, further comprising gluing the application material layer to the decorative cut before the insertion opening is filled with the filling material, and the filling of the insertion opening takes place through the application material layer.

8. The method according to claim 7, wherein the application material layer is fluid-permeable, and the method further comprises introducing the filling material into the insertion opening from the laminating side of the application material layer by oversaturating the application material layer with the filling material so that the filling material flows through the application material layer towards the visible side of the decorative cut so that the filling material flows into the insertion opening.

9. The method according to claim 6, further comprising introducing the filling material into the insertion opening of the decorative cut through openings cut into the application material layer.

10. The method according to claim 1, further comprising forming a gap between the functional body and the decorative cut when the functional body is inserted into the insertion opening, and filling the gap with the filling material.

11. The method according to claim 1, further comprising inserting a height compensation element on the adhesive side of the decorative cut before filling the insertion opening of the decorative cut with the filling material, and a thickness of the height compensation element is predetermined such that a rear side of the assembly corresponds to a flat plane.

12. A filling tool to produce the decorative element including the functional body by the method according claim 1, the filling tool including the sealing unit, an upper side of the sealing unit is formed by an upper side of a sealing layer of the sealing unit, and the decorative cut is placed onto the sealing layer to produce the decorative element.

13. The filling tool according to claim 12, wherein the filling tool includes a base body having a connecting side by which the base body and the sealing unit are configured to be connected to one another, and the base body and the sealing unit are formed separately from one another.

14. The filling tool according to claim 13, wherein the sealing unit is configured to be connected to the base body, the sealing unit is one of an assortment of sealing units, and the base body corresponds to one of the assortment of sealing units.

15. The filling tool according to claim 13, wherein the sealing unit includes:
a sealing layer configured to face the visible side of the decorative cut during a production of the decorative element;
a soft layer that includes a lower hardness than the sealing layer, and the soft layer is connected to the sealing layer; and
a carrier layer that is configured to carry the sealing layer and the soft layer.

16. The filling tool according to claim 15, further comprising an auxiliary filling opening arrangement with at least one auxiliary filling opening and air within the insertion opening is displaced by the filling material during filling.

17. The filling tool according to claim 16, wherein the at least one auxiliary filling opening of the auxiliary filling opening arrangement is a blind hole formed in the base body, and the blind hole opens at the connecting side of the base body or opens at the upper side the sealing unit.

18. The filling tool according to claim 16, wherein the auxiliary filling opening arrangement includes at least one second auxiliary filling opening, the at least one second auxiliary filling opening is a through hole, and the through hole completely penetrates the carrier layer or the sealing unit.

19. The filling tool according to claim 12, further comprising a ring element embedded flush in the sealing unit and flush with the upper side of the sealing unit, and the ring element has a different hardness than the upper side of the sealing unit.

20. A decorative element for a motor vehicle, the decorative element produced via the method according to claim 1, and the decorative element includes the functional body.
